(19) United States
(12) Patent Application Publication
(10) Pub. No.: US 2007/0131368 A1
(43) Pub. Date: Jun. 14, 2007

(54) Paperboard with discrete densified regions, process for making same, and laminate incorporating same

(75) Inventor: Zheming Xia, Florence, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/302,803

(22) Filed: Dec. 14, 2005

(51) Int. Cl. D21F 11/00; B31F 1/00

(52) U.S. Cl. 162/117; 162/205; 162/109; 162/123; 428/156; 428/537.5

(57) ABSTRACT

Paperboard is densified in selected discrete regions spaced apart along the board such that the effective caliper of the board (defined between the surfaces of the board in the areas outside the densified regions) remains essentially unchanged compared to an equivalent board that is not selectively densified. Thus, the effective density of the board also remains unchanged. The densified regions impart mechanical properties to the paperboard. The shapes, sizes, depths, and arrangement of the densified regions can be selected to impart increased strength in certain directions. For example, the ratio of the machine direction (MD) to cross-machine direction (CD) compressive strength can be manipulated through selective densification in accordance with the invention. The paperboard is useful in laminate structures and other uses.

### BACKGROUND OF THE INVENTION

1. Field of the Invention

The invention relates to paperboard, to processes for making paperboard, and to laminate paperboard structures.

2. Description of Related Art

Generally, paperboard strength and paperboard density go hand in hand. Thus, stronger board is denser than weaker board, assuming the same furnish and chemical additives in both cases. Higher density is achieved by wet pressing of the board, which also reduces its thickness or caliper. Thus, achieving greater strength in this manner also results in a thinner board. In many cases, it would be desirable to achieve greater strength, using the same amount of furnish and chemical additives per unit area, without any reduction in the effective caliper of the board. Existing processes do not allow this to be accomplished.

### BRIEF SUMMARY OF THE INVENTION

The invention provides a paperboard that is densified in selected discrete regions spaced apart along the board such that the effective caliper of the board (defined between the surfaces of the board in the areas outside the densified regions) remains essentially unchanged compared to an equivalent board that is not selectively densified. Thus, the effective density of the board also remains unchanged. The densified regions impart mechanical properties to the paperboard. The shapes, sizes, depths, and arrangement of the densified regions can be selected to impart increased strength in certain directions. For example, the ratio of the machine direction (MD) to cross-machine direction (CD) compressive strength can be manipulated through selective densification in accordance with the invention.

The process for selectively densifying paperboard entails pressing the board while still relatively wet between two surfaces at least one of which has raised areas for forming the densified regions. The paperboard thus has discrete densified regions whose thickness is reduced and whose density is increased relative to regions of the paperboard outside the densified regions. While the effective caliper of the board remains substantially unchanged (as determined by the non-densified regions), the mechanical properties of the board are enhanced in one or more directions.

In one embodiment of the invention, the densified regions comprise parallel grooves that are substantially longer than they are wide. The length of the grooves can extend along the machine direction, along the cross-machine direction, or at an oblique angle to the machine direction. Paperboard typically has a much higher compressive strength in the machine direction than in the cross-machine direction because the fibers tend to align with the machine direction during wet-forming of the web. This can be disadvantageous in some applications. Grooves extending in the cross-machine direction or at an oblique angle to the machine direction have been found to substantially affect the MD/CD compressive strength ratio (i.e., the ratio of the machine-direction compressive strength to the cross-machine direction compressive strength). In particular, such grooves have been found to reduce the MD/CD compressive strength ratio so that the disparity between MD compressive strength and CD compressive strength is not as great as for conventional paperboard.

Other configurations of the densified regions can be used, depending upon the objective in each particular case.

As noted, the selective densification of the discrete regions is carried out while the paperboard is wet. Preferably, the densification is carried out on the wet paperboard web coming from the forming section in a papermaking machine. The web at the time of densification advantageously has a moisture content of at least about 50 wt %, more preferably at least about 60 wt %, and still more preferably at least about 70 wt %. Thus, when the present specification and claims refer to selectively densifying the “wet paperboard”, this terminology is used herein to generally refer to paperboard having a moisture content of at least about 50 wt %.

Various devices can be used to selectively densify discrete regions of the paperboard web. In one embodiment, the web is passed by itself (i.e., not supported by any fabric) through a nip defined between two generally cylindrical press rolls. At least one of the press rolls has raised surfaces for densifying the discrete regions of the web. Both press rolls can have raised surfaces, as long as the surfaces are registered with each other so that the paperboard is selectively densified rather than being conventionally embossed. This can be accomplished by synchronizing the rotation of the two rolls either by mechanical coupling (e.g., gears) between the rolls, or by other means.

Alternatively, the web can be selectively densified by passing the web through a nip while the web is sandwiched between two fabrics. At least one of the fabrics has raised surfaces for densifying the discrete regions of the web.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of an apparatus and process for selectively densifying a wet paperboard web in accordance with one embodiment of the invention;

FIG. 2 is a cross-sectional view through the web along line 2-2 in FIG. 1;

FIG. 3 is a view similar to FIG. 2, showing an alternative embodiment of a selectively densified web in accordance with the invention;

FIG. 4 is a schematic diagram of a papermaking machine and process for making a paperboard in accordance with one embodiment of the invention;

FIG. 5 is a plan view of a paperboard in accordance with a further embodiment of the invention;

FIG. 6 is a plan view of a paperboard in accordance with yet another embodiment of the invention;

FIG. 7 is a plot showing test results for various selectively densified paperboards formed in accordance with the invention, compared with a control paperboard having no selective densification;

FIG. 8 is a perspective view of a wound paperboard tube incorporating paperboard plies in accordance with one embodiment of the invention; and

FIG. 9 is a cross-sectional view through the tube along line 9-9 in FIG. 8.

### DETAILED DESCRIPTION OF THE INVENTION

The present inventions now will be described more fully hereinafter with reference to the accompanying drawings, in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As noted, in many applications of paperboard for construction of structures, it would be desirable to enhance the mechanical properties of the board, such as its compressive strength in a particular direction, without having to use a greater mass of furnish per unit area (i.e., without increasing the board's basis weight), and without reduction in the effective caliper of the board. In other words, it would be desirable to preserve the effective density and effective caliper, while achieving the enhanced mechanical properties. For instance, in the construction of wound paperboard tubes, it is frequently necessary to achieve a specified wall thickness by using a suitable number of paperboard plies of suitable caliper. If the enhancement of mechanical properties necessitated reducing the caliper of one or more plies, then it might be necessary to increase the number of plies in order to achieve the specified wall thickness.

The objective of the invention, in contrast, is to enhance the mechanical properties without reduction in the effective caliper and without increase in basis weight or effective density. Accordingly, in the example of the wound tube, the same number of plies can be used to meet the specified wall thickness.

In accordance with the invention, paperboard while still relatively wet is densified in discrete regions by compressing these regions to reduce their thickness and increase their density and, hence, their compressive strength. Outside the discrete densified regions, the board thickness and density remain substantially unchanged (i.e., they are “non-densified”). Accordingly, the resulting board after dewatering and drying has discrete densified regions, but the effective caliper of the board, defined by the non-densified regions, is substantially the same as that of an otherwise identically produced board not subjected to the process for densifying the discrete regions.

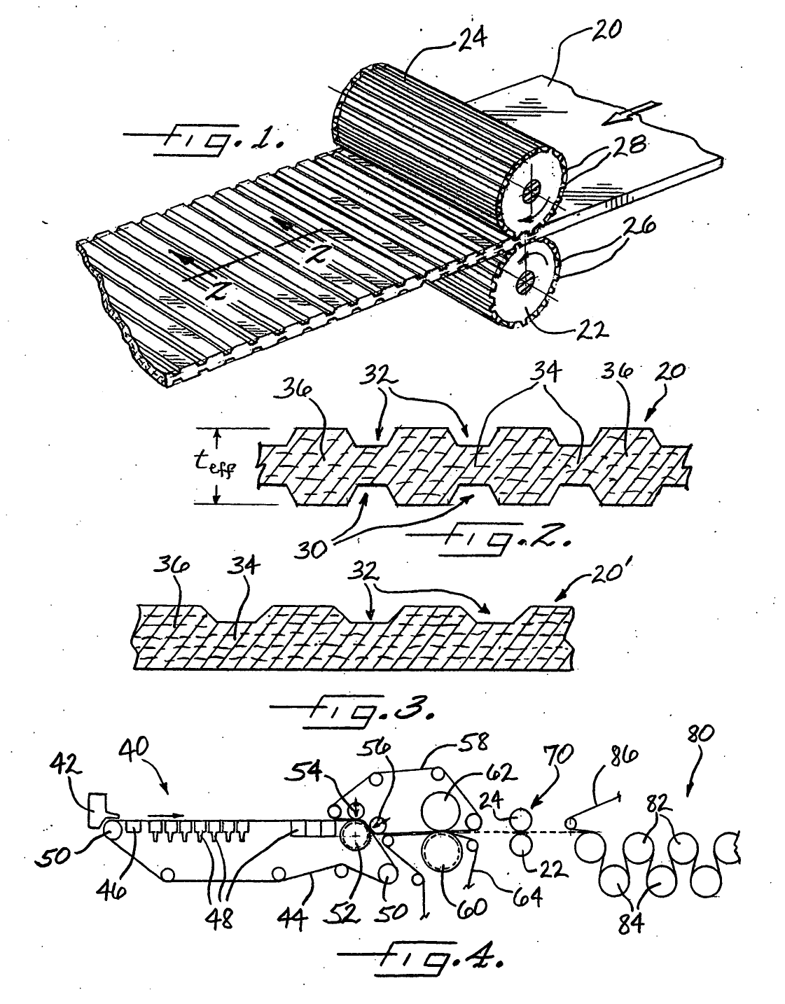

FIG. 1 depicts in schematic fashion an apparatus and process for selectively densifying discrete regions of a wet paperboard web 20 in accordance with one embodiment of the invention. The wet web 20 preferably comes from a wet end of a papermaking machine and is partially dewatered so that the web has a moisture content less than 90 wt % and more preferably less than about 80 wt %, such that the web has mechanical integrity. However, in order for the fibers to readily rearrange during the selective densification process, the moisture content must not be so low that the fibers are essentially locked in place. Thus, advantageously the moisture content should be at least about 50 wt %.

The densification process comprises pressing the wet web 20 between a first member 22 and a second member 24. The members in the illustrated embodiment are in the form of generally cylindrical press rolls that are arranged to form a nip therebetween. At least one of the rolls has raised surfaces for pressing discrete regions of the web to a greater extent than other regions. In the illustrated embodiment, the roll 22 has raised surfaces 26, and the other roll 24 also has raised surfaces 28. The raised surfaces 26, 28 are spaced apart in at least one direction along the surfaces of the respective rolls 22, 24. For instance, in the illustrated embodiment, the raised surfaces 26, 28 comprise projections similar to the teeth of a gear, the projections extending parallel to the axes of the rolls and extending the length of the rolls. The projections are uniformly spaced about the circumferences of the rolls, and the rolls are identical in diameter. The rolls are made to rotate in synchronized fashion by suitable means, not illustrated (e.g., mechanical coupling such as gears or the like, or stepper motors), such that the raised surfaces 26 of the roll 22 are rotationally aligned with the raised surfaces 28 of the other roll 24. In this manner, a series of discrete regions of the wet web 20, spaced apart along the direction of the movement of the web through the roll nip, are compressed between the raised surfaces 26, 28. These discrete regions are reduced in thickness and increased in density as a result of the compression. The regions of the web not compressed between the raised surfaces 26, 28 may also be compressed between the cylindrical surfaces of the rolls and thus may be reduced in thickness and increased in density relative to the starting board, but the regions compressed between the raised surfaces are increased in density to a greater extent.

The result, as illustrated in FIG. 2, is that the wet web 20 has spaced-apart grooves 30 in the side of the web contacted by the roll 22, and has grooves 32 in the other side contacted by the roll 24, with the grooves 30, 32 being aligned with each other. Accordingly, the web has densified regions 34 at the locations of the grooves, and relatively non-densified regions 36 in the intervening locations between the grooves. The density of the densified regions 34 exceeds that of the non-densified regions 36. The density difference preferably is at least about 10%, more preferably at least about 15%, still more preferably at least about 20%, and most preferably at least about 25%. The density of the non-densified regions can range from about 0.2 g/cc to about 0.8 g/cc. The density of the densified regions can range from about 0.22 g/cc to about 0.9 g/cc. As one example, the non-densified regions can have a density of approximately 0.4 g/cc and the densified regions can have a density exceeding that value by at least about 10%, more preferably at least about 15%, still more preferably at least about 20%, and most preferably at least about 25% greater (i.e., at least about 0.44 g/cc, more preferably 0.46 g/cc, still more preferably 0.48 g/cc, and most preferably at least about 0.50 g/cc).

From FIG. 2, it is apparent that the effective caliper or thickness, t_{eff}, of the web 20 is dictated by the thickness of the non-densified regions 36. This effective caliper can be substantially the same as for an otherwise identically formed web that is not subjected to the selective densification process. Consequently, the effective density of the selectively densified web can be substantially unchanged.

The web 20 shown in FIG. 2 is densified by a “two-sided” densification process. That is, the reduction in thickness of the densified regions 34 occurs from both sides of the web, such that there are groove or indentations in both sides. Alternatively, a web can be subjected to a “one-sided” densification process in accordance with the invention, by providing the raised surfaces on only one of the press members between which the web is pressed. For instance, in FIG. 1, the roll 22 can be replaced by a smooth cylindrical roll, while the roll 24 has raised surfaces 28 as shown. FIG. 3 illustrates a one-sided densified web 20′ made by such a process. The side of the web contacted by the smooth roll is planar, while the opposite side has grooves 32 formed by the raised surfaces of the other roll, which create densified regions 34.

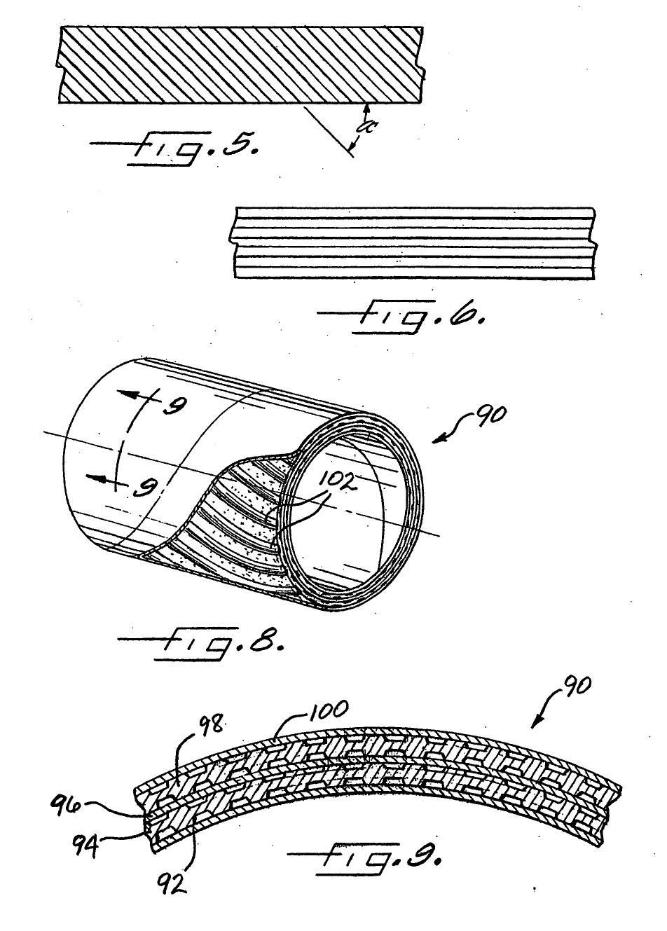

The selective densification process advantageously is integrated into the overall papermaking process in the papermaking machine. FIG. 4 illustrates one possible embodiment of a papermaking machine that can be used in accordance with the invention, but it will be understood that many variations on the type of components and their arrangement shown in FIG. 4 can be employed. The exemplary machine includes a fourdrinier forming section 40 comprising a headbox 42, a horizontal fourdrinier forming wire 44, a forming board 46, and suction boxes 48 for removing water from the wet web formed on the wire. The wire 44 travels in an endless loop about a series of guide rolls 50 and about a press roll 52 located near a downstream end of the wire loop. An aqueous pulp is injected from the headbox onto the moving forming wire. The pulp issuing from the headbox has a low consistency, typically comprising about 1% to 3% solids (fibers, additives, etc.) and the rest water. Water drains from the pulp through the wire, aided by the suction boxes. Thus, the web approaching the press roll 52 may have a solids content of approximately 10%.

The machine includes a first press comprising the press roll 52 that forms a first press nip with a first counter roll 54, and a second press comprising the press roll 52 forming a second press nip with a second counter roll 56. The counter rolls 54, 56 are disposed within an endless loop of a forming felt 58. The press roll 52 can have a grooved or blind-drilled face for receiving water pressed from the web in the first and second press nips. As the web exits the second press nip, it adheres to and follows the felt 58 because the felt is less porous than the forming wire 44. The felt 58 carries the web into a third press comprising a grooved or blind-drilled press roll 60 forming a nip with a counter roll 62. The counter roll 62 is within the loop of the felt 58. The press roll 60 is within an endless loop of a press felt 64. Thus, the web passes through the nip of the third press while sandwiched between the press felt 64 and the felt 58. Water expressed from the web in the third press nip is received in the felt 64 and in the open face of the press roll 60. Exiting the third press nip, the web adheres to and follows the felt 58 because it is less porous than the felt 64. At this point, the web may have a moisture content of about 50 wt % to about 75 wt %, depending on the extent of pressing in the press section of the machine.

Next, the web (shown in dashed line in FIG. 4) is advanced through a densification device 70, which selectively densifies discrete regions of the web as previously described. The device 70 can comprise a roll press having rolls 22, 24 generally as described in connection with FIG. 1. After selective densification, the web optionally can be further pressed and dewatered in one or more additional presses (not shown), if desired, although each additional press may densify the non-densified regions to a certain degree.

Finally, the web is advanced to a drying section 80, which thermally dries the web so that the web can be wound into a large roll. Various types of drying sections can be used. The illustrated drying section comprises a plurality of heated drying cylinders 82 that alternate with a plurality of reversing cylinders 84. The reversing cylinders are within the loop of a drying wire 86, and the drying cylinders are outside that loop, but the drying wire is arranged to wrap partially about each drying cylinder. The web directly contacts each drying cylinder and is pressed against it by the drying wire. The fully dried web exiting the drying section is wound into a roll in a reel-up (not shown).

It will be appreciated that the particular papermaking machine layout shown in FIG. 4 and described above is only one exemplary embodiment for purposes of explaining how the selective densification apparatus and process is integrated into the papermaking process. Many conceivable variations on the machine and process can be employed. For instance, the forming section can be other than a fourdrinier former, such as a series of cylinder formers. The first and second presses that press the web while still on the forming wire can be omitted. One or more presses can be added between the former and the selective densification apparatus, and/or between the selective densification apparatus and the drying section. Drying sections of different designs can be used.

The densification device 70 can have various configurations. As noted, the device can comprise a roll press wherein the rolls directly contact the web, such as in FIG. 1. Alternatively, the press can include one or two fabrics that contact one or both surfaces of the web. In this latter case, the raised surfaces that densify the discrete regions of the web can be formed on one of the fabrics, and the press rolls can be smooth cylindrical rolls. For example, either of the fabrics 58, 64 in the press shown in FIG. 4 can be configured with raised surfaces.

Additionally, the configuration of densified regions formed by the raised surfaces can vary depending upon the objectives for the paperboard. As already described, the discrete densified regions can be formed by grooves that extend widthwise (i.e., in the cross-machine direction) across the paperboard, as in FIG. 1. Alternatively, as shown in FIG. 5, the densified regions can be formed by grooves that extend at an oblique angle α to the machine direction, or that extend parallel to the machine direction as in FIG. 6. It is also possible, of course, for the densified regions to have other shapes besides elongate grooves.

Paperboard formed in accordance with the invention can be specifically tailored to achieve various objectives. For example, densified regions in the form of grooves as already described can be oriented in a particular direction to enhance the paperboard compressive strength in that direction. To assess the potential effects that can be achieved, a series of experiments were performed. A series of three paperboard sheets (#1 through #3) were made from identical pulp in substantially identical fashion and were pressed to partially dewater the sheets. Sheets #1 and #2 were made to substantially the same caliper, while sheet #3 had a substantially higher caliper than #1 and #2. The moisture content of each of the sheets was measured at this point, and the values were in the 60% range.

Each of the sheets was then segmented into five segments a through e and each segment was treated differently with respect to selective densification. One segment of each sheet was a control segment that was pressed with a smooth plate (i.e., no selective densification of discrete regions). The other four segments of each sheet were pressed with a plate having elongate projections for forming spaced groove-like indentations in one side of the sheet (similar to FIG. 3) so as to selectively densify the regions pressed by the projections. The direction of the projections relative to the machine direction of the sheet was varied for each of the four segments, as follows: 0° (MD), 90° (CD), 45°, and 60°. After selective densification, the sheets were dried, and then various tests were performed. In particular, measurements were made of basis weight and caliper (from which density was calculated), machine-direction compressive strength MD-STFI, and cross-machine direction compressive strength CD-STFI. The STFI test is a short-span compressive strength test similar to a ring crush test. A strip of paper (e.g., 1 cm by 10 cm) is gripped by two claws spaced 0.7 millimeter apart in the length direction of the strip, and is compressed by moving the claws toward each other until the strip buckles. The highest recorded force is divided by the width of the strip to yield the STFI value.

Next, two more sheets (#4 and #5) were made and selectively densified in the same manner as previously described, except that the pressing prior to selective densification was reduced to increase the moisture content to approximately 75%. The same tests as described above were carried out on these sheets. Finally, two more sheets (#6 and #7) were made and selectively densified in the same manner as previously described, except that the pressing prior to selective densification was increased to reduce the moisture content to approximately 40%. The same tests as described above were carried out on these sheets. The results of the tests are set forth in Table I below.

TABLE I

| | | | Basis | | | | | MD/CD |
|---|---|---|---|---|---|---|---|---|
| | MC | Groove | Weight | Caliper | Density | MD-STFI | CD-STFI | STFI |
| Sheet | (%) | Direction | (lb/msf) | (mils) | (lb/pt) | (lb/in) | (lb/in) | Ratio |
| 1-e | 61.5 | N/A | 48.6 | 15.27 | 3.18 | 46.95 | 23.28 | 2.0 |
| 2-d | 60.0 | N/A | 50.7 | 16.06 | 3.16 | 50.40 | 21.78 | 2.31 |
| 3-a | 62.0 | N/A | 65.9 | 20.94 | 3.15 | 61.82 | 31.88 | 1.94 |
| 1-a | 61.5 | 0° | 49.5 | 18.53 | 2.67 | 41.40 | 19.31 | 2.14 |
| 2-c | 60.0 | 0° | 48.8 | 17.75 | 2.75 | 43.88 | 19.40 | 2.26 |
| 3-b | 62.0 | 0° | 67.7 | 25.78 | 2.63 | 59.46 | 27.75 | 2.14 |
| 1-b | 61.5 | 90° | 48.6 | 17.91 | 2.72 | 39.38 | 20.55 | 1.92 |
| 2-a | 60.0 | 90° | 48.5 | 17.99 | 2.70 | 43.98 | 20.95 | 2.10 |
| 3-c | 62.0 | 90° | 65.3 | 23.60 | 2.77 | 53.03 | 29.13 | 1.80 |
| 1-c | 61.5 | 45° | 47.5 | 18.11 | 2.62 | 40.43 | 19.54 | 2.07 |
| 2-e | 60.0 | 45° | 51.7 | 18.63 | 2.78 | 41.30 | 20.29 | 2.04 |
| 3-d | 62.0 | 45° | 67.8 | 26.14 | 2.59 | 55.02 | 27.74 | 1.98 |
| 1-d | 61.5 | 60° | 48.1 | 18.03 | 2.67 | 42.95 | 19.92 | 2.16 |
| 2-b | 60.0 | 60° | 49.8 | 19.47 | 2.56 | 46.03 | 19.93 | 2.31 |
| 3-e | 62.0 | 60° | 66.6 | 25.05 | 2.66 | 56.39 | 27.20 | 2.07 |
| 4-d | 76.0 | N/A | 61.6 | 20.53 | 3.00 | 64.69 | 26.39 | 2.45 |
| 5-c | 75.0 | N/A | 63.2 | 21.03 | 3.00 | 56.73 | 26.28 | 2.16 |
| 4-c | 76.0 | 0° | 60.6 | 27.56 | 2.20 | 50.76 | 21.99 | 2.31 |
| 5-b | 75.0 | 0° | 64.0 | 28.23 | 2.27 | 55.11 | 22.22 | 2.48 |
| 5-e | 75.0 | 0° | 63.6 | 28.45 | 2.24 | 52.88 | 22.31 | 2.37 |
| 4-b | 76.0 | 90° | 62.8 | 28.03 | 2.24 | 43.78 | 23.92 | 1.83 |
| 5-a | 75.0 | 90° | 65.2 | 27.36 | 2.38 | 48.27 | 23.86 | 2.02 |
| 4-a | 76.0 | 45° | 61.9 | 28.22 | 2.19 | 48.48 | 23.28 | 2.08 |
| 4-e | 76.0 | 45° | 62.7 | 27.34 | 2.29 | 49.26 | 23.31 | 2.11 |
| 5-d | 75.0 | 45° | 64.2 | 28.06 | 2.29 | 50.82 | 24.62 | 2.06 |
| 6-a | 40.0 | N/A | 65.4 | 17.62 | 3.71 | 58.09 | 30.95 | 1.88 |
| 6-e | 40.0 | N/A | 67.9 | 17.97 | 3.78 | 57.96 | 29.79 | 1.95 |
| 7-d | 43.0 | N/A | 62.2 | 17.27 | 3.60 | 59.48 | 27.43 | 2.17 |
| 6-d | 40.0 | 0° | 66.3 | 19.27 | 3.44 | 56.00 | 29.52 | 1.90 |
| 7-c | 43.0 | 0° | 62.1 | 18.36 | 3.38 | 57.34 | 26.91 | 2.13 |
| 6-c | 40.0 | 90° | 64.6 | 18.89 | 3.42 | 54.69 | 29.72 | 1.84 |
| 7-b | 43.0 | 90° | 62.9 | 18.17 | 3.46 | 58.64 | 28.67 | 2.05 |
| 7-e | 43.0 | 90° | 65.1 | 18.40 | 3.54 | 58.13 | 27.73 | 2.10 |
| 6-b | 40.0 | 45° | 64.9 | 19.03 | 3.41 | 56.44 | 31.31 | 1.80 |
| 7-a | 43.0 | 45° | 62.1 | 17.74 | 3.50 | 58.99 | 30.06 | 1.96 |

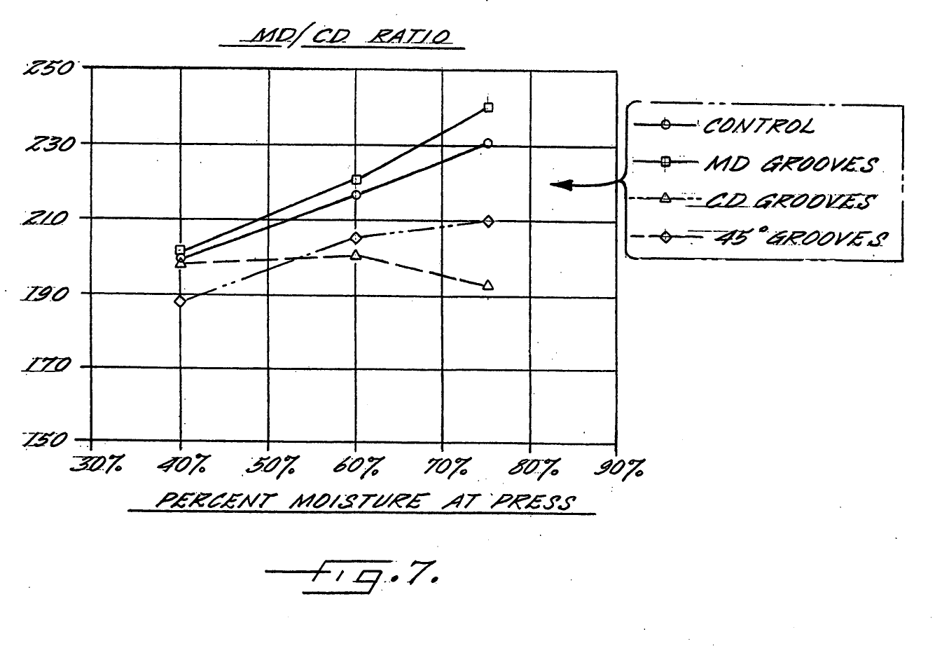

The MD/CD compressive strength ratio (expressed on a percentage basis) of the various samples were averaged and are plotted in FIG. 7 versus percent moisture content as a function of groove direction. This graph demonstrates that the direction of the densified regions can have a substantial influence on the MD/CD ratio of the paperboard, and that the influence is greater with higher moisture content at the time of selective densification. In particular, at 50% moisture content, only a slightly higher MD/CD ratio was obtained for the sheets having machine-direction grooves compared with the control sheets and with the sheets having cross-machine direction grooves. However, at 75% moisture content, there was a much more dramatic effect of groove direction on MD/CD ratio. The highest ratio was obtained with machine-direction grooves and the lowest with cross-machine direction grooves; the same was true at 60% moisture content.

Many additional variables could be explored for influencing MD and CD compressive strength and MD/CD compressive strength ratio. For instance, the sizes (relative to other board dimensions) and shapes of the densified regions likely may have an effect on the compressive strength properties of the paperboard, as may the spacing between the regions. Additionally, the temperature of the board during densification may also have an effect. The particular process used for densification (e.g., whether a roll press without fabrics, or a press with fabrics, etc.) may also be significant.

At any rate, the above-described initial series of tests clearly indicate that the selective densification of discrete regions of paperboard in accordance with the invention can strongly affect the mechanical properties of the board, in particular the board compressive strength parameters.

Paperboard formed in accordance with the invention can be used in many different applications. As but one example, FIGS. 8 and 9 show a wound paperboard tube 90 incorporating two paperboard plies formed in accordance with the invention. The tube comprises five plies in total, spirally wound one upon another and adhered together. The plies comprise, from inside to outside in the radial direction, an innermost ply 92 that is a conventionally formed ply; a selectively densified ply 94; a conventionally formed ply 96; another selectively densified ply 98; and an outermost ply 100 that is conventionally formed. As shown in FIG. 8, the densified regions 102 of the selectively densified plies extend spirally about the tube. Alternatively, the densified regions can extend axially along the tube; this is accomplished by orienting the densified regions at an angle, relative to the lengthwise direction of the ply, that is equal to the spiral wind angle of the ply. The greater compressive strength provided by the densified regions in a particular direction can be used to advantage in a wound tube construction to reinforce a particular strength property of the tube. For instance, the axially extending densified regions can enhance the axial buckling strength or column strength of the tube.

The paperboard in accordance with the invention can also be used in other laminate structures having configurations other than tubes, including flat laminates, angled laminates, and others. The paperboard can be laminated to other paperboard layers and/or to non-paperboard layers (e.g., polymer film, metal foil, etc.).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A process for manufacturing paperboard having enhanced compressive strength, the process comprising:
providing a wet paperboard web comprising fibrous furnish formed into a web, the web having opposite first and second surfaces defining a web thickness therebetween;
contacting the first surface of the web with a first member;
contacting the second surface of the web with a second member having a main surface and spaced-apart raised surfaces that project beyond the main surface, the raised surfaces contacting discrete regions of the web spaced apart from one another in at least one direction along the web;
causing the raised surfaces to compress the discrete regions of the web against the first member in such a manner that the web thickness in each of the discrete regions is reduced so as to be less than the web thickness outside the discrete regions such that the web in each discrete region has a density higher than outside the discrete regions; and
drying the web.

2. The process of claim 1, wherein the providing step comprises forming the wet paperboard web in a forming section having a forming wire on which aqueous papermaking pulp is deposited.

3. The process of claim 2, further comprising the step of advancing the wet web from the forming section to a press section comprising at least one dewatering press, and pressing the web in the at least one dewatering press to partially dewater the web.

4. The process of claim 3, further comprising the step of advancing the web to a densifying press comprising said first and second members wherein the discrete regions of the web are compressed to increase the density thereof.

5. The process of claim 4, further comprising the step of advancing the web to a drying section and drying the web in the drying section.

6. The process of claim 4, wherein the first and second members respectively comprise generally cylindrical first and second press rolls that form a nip therebetween, the second press roll having the raised surfaces, and the first and second press rolls directly contacting the first and second surfaces of the web, respectively.

7. The process of claim 6, wherein the first press roll has a smooth cylindrical surface such that all of the reduction in thickness of the discrete regions of the web occurs at the second surface of the web.

8. The process of claim 6, wherein the first press roll also includes spaced-apart raised surfaces that project beyond a main cylindrical surface of the first press roll, the first and second press rolls being rotated in synchronism such that the raised surfaces of the first press roll register with the raised surfaces of the second press roll and the discrete regions of the web are compressed between said raised surfaces, whereby the reduction in thickness of the discrete regions of the web occurs at both the first surface and the second surface of the web.

9. The process of claim 4, wherein the first and second members respectively comprise first and second fabrics, the second fabrics having the raised surfaces, and wherein the densifying press further comprises generally cylindrical first and second press rolls that form a nip therebetween, the first and second fabrics passing through the nip with the web sandwiched between the fabrics.

10. The process of claim 4, wherein the web is partially dewatered in the press section prior to being advanced to the densifying press.

11. The process of claim 4, wherein the web has a moisture content greater than about 50 wt % at the time of being treated in the densifying press.

12. The process of claim 4, wherein the web has a moisture content greater than about 60 wt % at the time of being treated in the densifying press.

13. The process of claim 4, wherein the web has a moisture content greater than about 70 wt % at the time of being treated in the densifying press.

14. A paperboard having enhanced compressive strength, comprising:
a sheet comprising a web of papermaking pulp that is wet-formed, dewatered, pressed, and dried, the sheet comprising non-densified regions of a first density, the non-densified regions having opposite first and second surfaces, a thickness of the non-densified regions being defined between the first and second surfaces, the sheet further comprising densified regions formed by pressing the densified regions while the sheet is wet, the densified regions being spaced apart in at least one direction and interspersed with the non-densified regions, the densified regions having a thickness less than the thickness of the non-densified regions, and the densified regions having a density that is greater than a density of the non-densified regions.

15. The paperboard of claim 14, wherein the density of the non-densified regions is about 0.2 g/cc to about 0.8 g/cc.

16. The paperboard of claim 15, wherein the density of the densified regions is at least about 10% greater than the density of the non-densified regions.

17. The paperboard of claim 14, wherein the densified regions comprise spaced-apart parallel grooves, each groove having a length substantially greater than a width of the groove.

18. The paperboard of claim 17, the sheet having a machine direction and a cross-machine direction, wherein the length of the grooves extends in the machine direction of the sheet.

19. The paperboard of claim 17, the sheet having a machine direction and a cross-machine direction, wherein the length of the grooves extends in the cross-machine direction of the sheet.

20. The paperboard of claim 17, the sheet having a machine direction and a cross-machine direction, wherein the length of the grooves extends at an oblique angle to the machine direction of the sheet.

21. A laminate, comprising:
a plurality of flexible material layers adhesively joined to one another to form a laminate, at least one of the layers comprising a sheet comprising a web of papermaking pulp that is wet-formed, dewatered, pressed, and dried, the sheet comprising non-densified regions of a first density, the non-densified regions having opposite first and second surfaces, a thickness of the non-densified regions being defined between the first and second surfaces, the sheet further comprising densified regions formed by pressing the densified regions while the sheet is wet, the densified regions being spaced apart in at least one direction and interspersed with the non-densified regions, the densified regions having a thickness less than the thickness of the non-densified regions, and the densified regions having a density that is greater than a density of the non-densified regions.

22. The laminate of claim 21, wherein the laminate has a configuration of a tube by wrapping the layers about an axis.
